(19) United States
(12) Patent Application Publication
(10) Pub. No.: US 2006/0178548 A1
(43) Pub. Date: Aug. 10, 2006

(54) Method for stabilization of flyash and scrubber residues

(76) Inventor: Keith Edward Forrester, Meredith, NH (US)

Correspondence Address: Keith E. Forrester, 78 Tracy Way, Meredith, NH, 03253, US

(21) Appl. No.: 11/350,208

(22) Filed: Feb. 8, 2006

Related U.S. Application Data
(60) Provisional application No. 60/651,423, filed on Feb. 9, 2005.

(51) Int. Cl. B09B 3/00

(52) U.S. Cl. 588/256

(57) ABSTRACT

This invention provides a method for stabilization of flyash and scrubber residues subject to acid and water leaching tests or leach conditions by addition of stabilizing agents and pH reducing agents, such that leaching of lead is inhibited to desired levels. The resultant waste after stabilization is suitable for disposal as RCRA non-hazardous waste.

### BACKGROUND OF THE INVENTION

Heavy metal bearing air pollution unit collected flyash and air pollution control unit generated scrubber residue combinations from mass burn refuse incinerators, refuse derived fuel incinerators, fossil fuel combustors, steel mills, foundries, and Pb smelters may be deemed “Hazardous Waste” by the United States Environmental Protection Agency (USEPA) pursuant to 40 C.F.R. Part 261 and also deemed hazardous under similar regulations in other countries such as Japan, Switzerland, Germany, United Kingdom, Mexico, Australia, Canada, Taiwan, European Countries, India, and China, and deemed special waste within specific regions or states within those countries, if containing designated leachate solution-soluble and/or sub-micron filter-passing particle sized lead (Pb) above levels deemed hazardous by those country, regional or state regulators. Scrubber residue is most commonly a lime-based solid product produced from the interaction between either dry or slurry lime as CaOH or CaOH(x) and acid gas components derived from the combustion of refuse or fossil fuels, processing of steel, alloys and other industrial operations which generate gases as sulfur dioxides and hydrogen chlorides regulated under the Clean Air Act and Amendments thereto. Some scrubbers referred to as dry lime scrubbers operate by injecting a fine-powder dry lime prior to a baghouse collection unit, which produces a high level of pH and excess lime in the scrubber residue due to incomplete lime consumption by acid gas. Most scrubbers use a wet slurry lime, hydrated on-site in mixing units and injected into a spray tower which provides for a very efficient lime consumption and lower lime excess remaining in the scrubber residue stream. Both scrubber methods produce excess lime and thus a residue with a pH value well above the optimum pH range of neutral to approximately 10.5 units for lead solubility control.

In the United States, any industrial solid waste such as collected flyash and scrubber residue can be defined as Hazardous Waste either because it is “listed” in 40 C.F.R., Part 261 Subpart D, federal regulations adopted pursuant to the Resource Conservation and Recovery Act (RCRA), or because it exhibits one or more of the characteristics of a Hazardous Waste as defined in 40 C.F.R. Part 261, Subpart C. The hazard characteristics defined under 40 CFR Part 261 are: (1) ignitability, (2) corrosivity, (3) reactivity, and (4) toxicity as tested under the Toxicity Characteristic Leaching Procedure (TCLP). 40 C.F.R., Part 261.24(a), contains a list of heavy metals and their associated maximum allowable concentrations. If a heavy metal, such as lead, exceeds its maximum allowable concentration from a solid waste, when tested using the TCLP analysis as specified at 40 C.F.R. Part 261 Appendix 2, then the solid waste is classified as RCRA Hazardous Waste. The USEPA TCLP test uses a dilute acetic acid either in deionized water (TCLP fluid 2) or in de-ionized water with a sodium hydroxide buffer (TCLP fluid 1). Both extract methods attempt to simulate the leachate character from a decomposing trash landfill in which the solid waste being tested for is assumed to be disposed in and thus subject to rainwater and decomposing organic matter leachate combination . . . or an acetic acid leaching condition. Waste containing leachable heavy metals is currently classified as hazardous waste due to the toxicity characteristic, if the level of TCLP analysis is above 0.2 to 100 milligrams per liter (mg/L) or parts per millions (ppm) for specific heavy metals. The TCLP test is designed to simulate a worst-case leaching situation . . . that is a leaching environment typically found in the interior of an actively degrading municipal landfill. Such landfills normally are slightly acidic with a pH of approximately 5±0.5. Countries outside of the US also use the TCLP test as a measure of leaching such as Thailand, Taiwan, and Canada. Thailand also limits solubility of Cu and Zn, as these are metals of concern to Thailand groundwater. Switzerland, Mexico, Europe and Japan regulate management of solid wastes by measuring heavy metals and salts as tested by a sequential leaching method using carbonated water simulating rainwater, synthetic rainwater and de-ionized water sequential testing. Additionally, U.S. EPA land disposal restrictions prohibit the land disposal of solid waste leaching in excess of maximum allowable concentrations upon performance of the TCLP analysis. The land disposal regulations require that hazardous wastes are treated until the heavy metals do not leach at levels from the solid waste at levels above the maximum allowable concentrations prior to placement in a surface impoundment, waste pile, landfill or other land disposal unit as defined in 40 C.F.R. 260.10.

Suitable acetic acid leach tests include the USEPA SW-846 Manual described Toxicity Characteristic Leaching Procedure (TCLP) and Extraction Procedure Toxicity Test (EP Tox) now used in Canada. Briefly, in a TCLP test, 100 grams of waste are tumbled with 2000 ml of dilute and buffered or non-buffered acetic acid for 18 hours and then filtered through a 0.75 micron filter prior to nitric acid digestion and final ICP analyses for total “soluble” metals. The extract solution is made up from 5.7 ml of glacial acetic acid and 64.3 ml of 1.0 normal sodium hydroxide up to 1000 ml dilution with reagent water.

Suitable water leach tests include the Japanese leach test which tumbles 50 grams of composited waste sample in 500 ml of water for 6 hours held at pH 5.8 to 6.3, followed by centrifuge and 0.45 micron filtration prior to analyses. Another suitable distilled water CO₂ saturated method is the Swiss protocol using 100 grams of cemented waste at 1 cm³ in two (2) sequential water baths of 2000 ml. The concentration of lead and salts are measured for each bath and averaged together before comparison to the Swiss criteria.

Suitable citric acid leach tests include the California Waste Extraction Test (WET), which is described in Title 22, Section 66700, “Environmental Health” of the California Health & Safety Code. Briefly, in a WET test, 50 grams of waste are tumbled in a 1000 ml tumbler with 500 grams of sodium citrate solution for a period of 48 hours. The concentration of leached lead is then analyzed by Inductively-Coupled Plasma (ICP) after filtration of a 100 ml aliquot from the tumbler through a 45 micron glass bead filter.

The present invention provides a method of reducing the solubility of Pb bearing flyash and scrubber residue combinations produced from refuse incinerators, fossil fuel combustors, smelters, mills and foundries which utilize acid gas scrubbing technology incorporating calcium oxide (CaO) in either hydrated or non-hydrated form. Pb is controlled by the invention under TCLP, SPLP, CALWET, MEP, rainwater and surface water leaching conditions as well as under regulatory water extraction test conditions as defined by waste control regulations in Thailand, Taiwan, Japan, Canada, UK, Mexico, Switzerland, Germany, Sweden, The Netherlands and under American Nuclear Standards for sequential leaching of wastes by de-ionized water. Unlike the present invention, prior art has focused on reducing solubility of Pb in ash residues by application of stabilizers such as cement, sulfides, silicates and water soluble phosphoric acid (Forrester U.S. Pat. No. 5,245,114) and use of a water insoluble and polymer coated phosphate sources (Forrester U.S. Pat. No. 5,860,908) without consideration of the final pH of the leachate test and the value of adjusting the matrix pH to a lower pH value for improved solubility control of Pb regardless of mineral type. These previous methods fail to recognize the importance of providing for water soluble or water insoluble phosphate source for apatite mineral(s) formation or other stabilizing agents in combination with an inexpensive acid capable of lowering the extraction fluid leach test pH to a range which improves apatite or other mineral formations and provides for low solubility range for all Pb minerals including but not limited to PbO, PbS, PbCl2, PbSO4, PbCO3, and lead phosphate. This method of combined acidification and stabilization is of particular value in locations where the flyash and scrubber residue product is separated at the production facility from bottom ash and thus is tested and disposed of separately. A majority of in-line ash stabilization systems used to date have benefited from the dilution of the lead in flyash and scrubber residue by bottom ash mixing, and thus providing the mixture of combined ash to pass the subject regulatory leaching test. The bottom ash in refuse incinerators is 50% to 90% of the combined ash weight depending on whether the incinerator is a mass-burn facility or a refuse-derived fuel plant which removed ferrous, glass and non-ferrous metals prior to the remaining fluff combustion.

U.S. Pat. No. 5,202,033 describes an in-situ method for decreasing Pb TCLP leaching from solid waste using a combination of solid waste additives and additional pH controlling agents from the source of phosphate, carbonate, and sulfates.

U.S. Pat. No. 5,037,479 discloses a method for treating highly hazardous waste containing unacceptable levels of TCLP Pb such as lead by mixing the solid waste with a buffering agent selected from the group consisting of magnesium oxide, magnesium hydroxide, reactive calcium carbonates and reactive magnesium carbonates with an additional agent which is either an acid or salt containing an anion from the group consisting of Triple Superphosphate (TSP), ammonium phosphate, diammonium phosphate, phosphoric acid, boric acid and metallic iron.

U.S. Pat. No. 4,889,640 discloses a method and mixture from treating TCLP hazardous lead by mixing the solid waste with an agent selected from the group consisting of reactive calcium carbonate, reactive magnesium carbonate and reactive calcium magnesium carbonate.

U.S. Pat. No. 4,652,381 discloses a process for treating industrial wastewater contaminated with battery plant waste, such as sulfuric acid and heavy metals by treating the waste waster with calcium carbonate, calcium sulfate, calcium hydroxide to complete a separation of the heavy metals. However, this is not for use in a solid waste situation.

### SUMMARY OF THE INVENTION

The present invention discloses a Pb bearing flyash and scrubber residue combination stabilization method through contact of flyash and scrubber residue with stabilizing agents including sulfates, sulfides, carbonates, silicates, Portland cement, cement kiln dust, phosphates, and combinations thereof which are properly chosen to complement the lead substitution into low solubility lead minerals, in combination with an acid reducing agent capable of lowering the flyash and scrubber residue mixture leach test extract pH to a range where the solubility of lead minerals within the flyash and scrubber residue is at a low level regardless of lead mineral form.

It is anticipated that the stabilizer and acid combination can be used for both reactive compliance and remedial actions as well as proactive leaching reduction means such that generated ash and residue does not exceed hazardous waste criteria. The preferred method of application of stabilizer agents would be in-line within the ash and residue collection units, and thus eliminating the need for expensive ash conditioning or mixing equipment and also allowed under USEPA regulations (RCRA) as totally enclosed, in-line exempt method of TCLP stabilization without the need for a RCRA Part B hazardous waste treatment and storage facility permit.

### DETAILED DESCRIPTION

Environmental regulations throughout the world such as those developed by the USEPA under RCRA and CERCLA require heavy metal bearing waste and material producers to manage such materials and wastes in a manner safe to the environment and protective of human health. In response to these regulations, environmental engineers and scientists have developed numerous means to control heavy metals, mostly through chemical applications which convert the solubility of the material and waste character to a less soluble form, thus passing leach tests and allowing the wastes to be either reused on-site or disposed at local landfills without further and more expensive control means such as hazardous waste disposal landfills or facilities designed to provide metals stabilization. The primary focus of scientists has been on reducing solubility of heavy metals such as lead, cadmium, chromium, arsenic and mercury, as these were and continue to be the most significant mass of metals contamination in our environment. Materials such as paints, cleanup site wastes such as battery acids, and industrial operations produced ash and scrubber wastes from fossil fuel combustors, smelters and incinerators are major lead sources.

Scrubber residue is most commonly a lime-based solid product produced from the interaction between either dry or slurry lime as CaOH or CaOH(x) and acid gas components derived from the combustion of refuse or fossil fuels, processing of steel, alloys and other industrial operations which generate gases as sulfur dioxides and hydrogen chlorides regulated under the Clean Air Act and Amendments thereto. Some scrubbers referred to as dry lime scrubbers operate by injecting a fine-powder dry lime prior to a baghouse collection unit, which produces a high level of pH and excess lime in the scrubber residue due to incomplete lime consumption by acid gas. Most scrubbers use a wet slurry lime, hydrated on-site in mixing units and injected into a spray tower which provides for a very efficient lime consumption and lower lime excess remaining in the scrubber residue stream. Both scrubber methods produce excess lime and thus a residue with a pH value well above the optimum pH range of neutral to approximately 10.5 units for lead solubility control.

There exists a demand for improved and less costly control methods of lead from flyash and scrubber residues, that allows for Pb stabilization into stable minerals such as phosphate apatite of lead silicate. The present invention discloses a Pb bearing flyash and scrubber residue combination ash method through contact with stabilizing agent including phosphates, cements, cement kiln dust, silicates, sulfides, sulfates, carbonates, and combinations thereof, and an acid reducing agent capable of lowering the leach test extract pH to a level where all lead minerals within the ash matrix are at a low level of solubility.

It is anticipated that the stabilizers and acid reducing agent can be used for RCRA compliance actions such that generated waste does not exceed appropriate TCLP hazardous waste criteria, and under TCLP or CERCLA (Superfund) response where stabilizers and acid agent are added to waste piles or storage vessels previously generated. The preferred method of application of stabilizers would be in-line within the ash and residue handling systems, and thus allowed under RCRA as a totally enclosed, in-line or exempt method of TCLP stabilization without the need for a RCRA Part B hazardous waste treatment and storage facility permit(s).

The stabilizing agents including silicates, sulfates, sulfides, carbonates, cement, cement kiln dust, calcium phosphates, phosphates, and combinations thereof with the phosphate group including but not limited to wet process amber phosphoric acid, wet process green phosphoric acid, aluminum finishing Coproduct blends of phosphoric acid and sulfuric acid, technical grade phosphoric acid, monoammonia phosphate (MAP), diammonium phosphate (DAP), single superphosphate (SSP), triple superphosphate (TSP), hexametaphosphate (HMP), tetrapotassium polyphosphate, dicalcium phosphate, tricalcium phosphate, monocalcium phosphate, phosphate rock, pulverized forms of all above dry phosphates, and combinations thereof, and combination with pH reducing agents would be selected through laboratory treatability and/or bench scale testing to provide sufficient control of metals solubility. In certain cases, such as with the use of amber and green phosphoric acid acid, phosphates may embody sulfuric acid, vanadium, iron, aluminum and other complexing agents which could also provide for a single-step formation of complexed heavy metal minerals and pH reducing agents. The stabilizer and pH adjusting agent type, dose rate, contact duration, and application means would be engineered for each type of ash and scrubber residue production facility.

Although the exact stabilization formation minerals are undetermined at this time, it is expected that when lead comes into contact with the stabilizing agents and pH reducing agents in the presence of flyash and scrubber residue and sufficient reaction time and energy, low extract fluid soluble minerals form such as a Pb substituted hydroxyapatite, through substitution or surface bonding, which is less soluble than the heavy metal element or molecule originally in the material or waste. The combination of low solubility range pH and stabilizer will provide a dual control method of lead solubility control . . . which is important in applications where complete formation of low soluble lead minerals is not achieved. Such incomplete lead mineral formation environments could occur where phosphates are consumed by iron and calcium within the ash and residue, where available stabilizer levels are too low for complete Pb stabilization, where stabilizer to lead contact is incomplete such as with dry ash conditioning systems or where dry ash and residue agglomerating systems are selected such as with roll compaction briquette units which require low water content.

The optimum leaching test fluid pH for obtaining the lowest lead solubility will vary from ash and scrubber residue type and production, although anticipated to range from a final extract pH of 7.5 to 10.5 units. As leach tests used throughout the world also vary as to extractor size, sample size, tumbling method, extract fluid (i.e., water, acetic acid, citric acid, synthetic rainwater, carbonated water, distilled water), the optimum pH range will be obtained through varying degrees of pH adjusting agent dose as well as Pb stabilizer dose. One skilled in the art of laboratory treatability studies will be able to develop two-dimensional dose-response relationships for a specific ash and residue combination and specific leaching method, and thus determine the best cost means of stabilization and pH adjusting agent combination.

Examples of suitable stabilizing agents include, but are not limited to sulfates, sulfides, silicates, cements, cement kiln dust, calcium phosphates, phosphate fertilizers, phosphate rock, pulverized phosphate rock, calcium orthophosphates, monocalcium phosphate, dicalcium phosphate, tricalcium phosphate, trisodium phosphates, natural phosphates, phosphoric acids, dry process technical grade phosphoric acid, wet process green phosphoric acid, wet process amber phosphoric acid, black phosphoric acid, merchant grade phosphoric acid, aluminum finishing phosphoric and sulfuric acid solution, hypophosphoric acid, metaphosphoric acid, hexametaphosphate, tertrapotassium polyphosphate, polyphosphates, trisodium phosphates, pyrophosphoric acid, fishbone phosphate, animal bone phosphate, herring meal, bone meal, phosphorites, and combinations thereof. Salts of phosphoric acid can be used and are preferably alkali metal salts such as, but not limited to, trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof. Examples of suitable pH adjusting agents include sulfuric acid, nitric acid, hydrochloric acid, and industrial waste acids. It is anticipated that sulfuric acid and hydrochloric acid and industrial waste products containing such acids will be the least cost means of reducing the ash and scrubber residue leach test pH to a level where lead minerals are least soluble.

The amounts of stabilizing agent and pH adjusting agent used, according to the method of invention, depend on various factors including desired solubility reduction potential, leaching test method, desired mineral toxicity, and desired mineral formation relating to toxicological and site environmental control objectives. It has been found that addition of 1% wet process phosphoric acid and 4% sulfuric acid by weight of incinerator ash and scrubber residue was sufficient for TCLP Pb stabilization to less than RCRA 5.0 ppm limit. However, the foregoing is not intended to preclude yet higher or lower usage of stabilizing agent(s), pH reducing agents, or combinations.

The examples below are merely illustrative of this invention and are not intended to limit it thereby in any way.

### EXAMPLE

Mass burn refuse incinerator flyash and wet lime scrubber residue combination produced from a municipal waste incinerator facility in Canada using lime acid gas control and flyash collection by baghouse, was combined with 1% by weight wet process produced [75%] green phosphoric acid and 4% by weight [98%] technical grade sulfuric acid, and also tested separately for each acid type to compare costs and relate to the TCLP limit of 5.0 ppm. The mixed stabilized sample was not allowed to cure and was subjected to TCLP analyses Method 1311 and extract digestion by EPA method 200.7.

TABLE 1

| Addition | TCLP Pb (ppm) | Fluid pH (18 hr) | Cost/ton ash ($) |
|---|---|---|---|
| Baseline | 232.00 | 12.8 | 0.00 |
| 1% PO4 | 139.0 | 12.4 | 4.50 |
| 2% PO4 | 89.0 | 11.7 | 9.00 |
| 4% PO4 | 5.1 | 10.2 | 18.00 |
| 4% SO4 | 22.5 | 11.1 | 2.00 |
| 6% SO4 | 19.80 | 9.9 | 3.00 |
| 1% PO4 + | 1.5 | 10.2 | 6.50 |
| 4% SO4 | | | |

The foregoing results in Example 1 readily established the operability of the present process to stabilize lead bearing ash and scrubber residue thus reducing leachability to less than the regulatory limit at a combined sulfuric acid and phosphoric acid cost well below the cost of using the phosphate stabilizer alone. Given the effectiveness of the stabilizing agent and pH reducing agent in causing lead to stabilize as presented in the Table 1, it is believed that an amount of the stabilization and pH reducing agents equivalent to less than 10% by weight of ash and scrubber residue mixtures should be effective.

While this invention has been particularly shown and described with reference to preferred embodiments thereof, it will be understood by those skilled in the art that various changes in form and details may be made therein without departing from the spirit and scope of the invention as defined by the appended claims.

I claim:

1. A method of reducing the solubility of lead bearing flyash and scrubber residue mixtures, comprising contacting flyash and scrubber residue mixture with at least one stabilizing agent and one pH reducing agent in an amount effective in reducing the leaching of lead from the flyash and scrubber residue mixture to a level no more than non-hazardous levels as determined in an EPA TCLP test, performed on the stabilized material or waste, as set forth in the Federal Register, vol. 55, no. 126, pp. 26985-26998 (Jun. 29, 1990).

2. The method of claim 1, wherein the stabilizing agent is selected from the group consisting of phosphates, sulfates, sulfides, Portland cement, silicates, cement kiln dust, ferric chloride and mineral complexing agent combinations, wet process amber phosphoric acid, wet process green phosphoric acid, coproduct phosphoric acid solution from aluminum polishing, technical grade phosphoric acid, hexametaphosphate, polyphosphate, calcium orthophosphate, superphosphates, triple superphosphates, phosphate fertilizers, phosphate rock, bone phosphate, fishbone phosphates, tetrapotassium polyphosphate, monocalcium phosphate, monoammonia phosphate, diammonium phosphate, dicalcium phosphate, tricalcium phosphate, trisodium phosphate, salts of phosphoric acid, and combinations thereof.

3. A method of claim 1, wherein the pH adjusting agent is selected from the group consisting of phosphoric acid, sulfuric acid, nitric acid, hydrochloric acid, waste process acid, coproduct solution, and combinations thereof.

4. A method of claim 1 wherein reduction of solubility is to a level no more than non-hazardous levels as determined under leach tests required by regulation in countries other than the USA including but not limited to Switzerland, Mexico, Taiwan, Japan, Thailand, China, Canada, Germany, Europe.

5. A method of reducing the solubility of lead bearing scrubber residue, comprising contacting scrubber residue with at least one stabilizing agent and one pH reducing agent in an amount effective in reducing the leaching of lead from the scrubber residue mixture to a level no more than non-hazardous levels as determined in an EPA TCLP test, performed on the stabilized material or waste, as set forth in the Federal Register, vol. 55, no. 126, pp. 26985-26998 (Jun. 29, 1990).

6. The method of claim 5, wherein the stabilizing agent is selected from the group consisting of phosphates, sulfates, sulfides, Portland cement, silicates, cement kiln dust, ferric chloride and mineral complexing agent combinations, wet process amber phosphoric acid, wet process green phosphoric acid, coproduct phosphoric acid solution from aluminum polishing, technical grade phosphoric acid, hexametaphosphate, polyphosphate, calcium orthophosphate, superphosphates, triple superphosphates, phosphate fertilizers, phosphate rock, bone phosphate, fishbone phosphates, tetrapotassium polyphosphate, monocalcium phosphate, monoammonia phosphate, diammonium phosphate, dicalcium phosphate, tricalcium phosphate, trisodium phosphate, salts of phosphoric acid, and combinations thereof.

7. A method of claim 5, wherein the pH adjusting agent is selected from the group consisting of phosphoric acid, sulfuric acid, nitric acid, hydrochloric acid, waste process acid, coproduct solution, and combinations thereof.

8. A method of claim 1 wherein reduction of solubility is to a level no more than non-hazardous levels as determined under leach tests required by regulation in countries other than the USA including but not limited to Switzerland, Mexico, Taiwan, Japan, Thailand, China, Canada, Germany, Europe.
